(19) United States
(12) Patent Application Publication
(10) Pub. No.: US 2026/0159217 A1
(43) Pub. Date: Jun. 11, 2026

(54) VEHICLE COMPONENT FAIRING AND RELATED MOUNTING SYSTEM

(71) Applicant: Gulfstream Aerospace Corporation, Savannah, GA (US)

(72) Inventors: Ricky L. Odey, JR., Savannah, GA (US); Shem e'Silva, Savannah, GA (US)

(73) Assignee: Gulfstream Aerospace Corporation, Savannah, GA (US)

(21) Appl. No.: 19/179,134

(22) Filed: Apr. 15, 2025

Related U.S. Application Data
(60) Provisional application No. 63/638,188, filed on Apr. 24, 2024.

(51) Int. Cl. B64C 1/36; B64C 7/00; H01Q 1/28

(52) U.S. Cl. CPC B64C 1/36; B64C 7/00; H01Q 1/286

(57) ABSTRACT

Disclosed herein is a system that is mountable to an outer panel of a vehicle, such as an aircraft. A disclosed version of the system includes an an antenna component, a carrier frame, support fittings, and an aerodynamic fairing. The antenna component is coupled to the carrier frame, which includes a plurality of clevis attachment features. Each support fitting is couplable between one of the clevis attachment features and the outer panel of the vehicle. The fairing has an upper section and a lower section. The upper section has an opening defined therein. The lower section is configured and arranged for coupling to the outer panel of the vehicle. The opening is shaped and sized to accommodate at least a portion of the carrier frame, which is coupled to the upper section of the fairing.

### CROSS-REFERENCE TO RELATED APPLICATION

This application claims the benefit of U.S. provisional patent application No. 63/638,188, filed Apr. 24, 2024.

### TECHNICAL FIELD

Embodiments of the subject matter described herein relate generally to vehicle components. More particularly, embodiments of the subject matter relate to a fairing for an aircraft component, such as a communication antenna.

### BACKGROUND

Vehicles such as aircraft, automobiles, and watercraft often include components that are mounted to or integrated with exterior panels, features, or structures. For example, automobiles may utilize exterior-mounted cameras, spoilers, antennas, sensors, and the like. Likewise, aircraft may utilize fuselage-mounted instruments, light fixtures, communication equipment, antennas, and the like. Mounting of such components can be challenging and often requires a balancing of various factors, such as weight, cost, structural integrity, decorative appearance, and aerodynamic performance.

Accordingly, it is desirable to have a component fairing for a component that is mounted to or integrated with the exterior of a host vehicle. In addition, it is desirable to have a component fairing and associated mounting system that is robust, secure, and aerodynamic. Furthermore, other desirable features and characteristics will become apparent from the subsequent detailed description and the appended claims, taken in conjunction with the accompanying drawings and the foregoing technical field and background.

### BRIEF SUMMARY

A system for mounting a component to an outer panel of a vehicle is described herein. A disclosed embodiment of the system includes: a carrier frame configured to receive and hold the component; a plurality of support fittings; and a fairing. Each support fitting is couplable between the carrier frame and the outer panel of the vehicle, and the support fittings are configured to physically attach the carrier frame to the outer panel of the vehicle. The fairing has an upper section with an opening defined therein. The fairing has a lower section configured and arranged for coupling to the outer panel of the vehicle. The opening in the fairing is shaped and sized to accommodate at least a portion of the carrier frame. The carrier frame is coupled to the upper section of the fairing.

A system configured to be mounted to an outer panel of a vehicle is also described herein. A disclosed embodiment of the system includes: an antenna component; a carrier frame coupled to the antenna component; a plurality of support fittings; and an aerodynamic fairing. The carrier frame has a plurality of clevis attachment features. Each support fitting is couplable between one of the clevis attachment features and the outer panel of the vehicle. The aerodynamic fairing has an upper section with an opening defined therein. The aerodynamic fairing also has a lower section configured and arranged for coupling to the outer panel of the vehicle. The opening in the fairing is shaped and sized to accommodate at least a portion of the carrier frame. The carrier frame is coupled to the upper section of the fairing.

Also described herein is a vehicle, such as an aircraft, that includes an embodiment of the system summarized above.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a top-front perspective view of an aircraft with a component and an associated fairing mounted thereto, in accordance with certain embodiments of the invention;

FIG. 2 is a top-front perspective view that depicts a section of an aircraft fuselage with an antenna and an associated fairing mounted thereto, in accordance with certain embodiments of the invention;

FIG. 3 is a top view of the section of the aircraft fuselage shown in FIG. 2;

FIG. 4 is a top perspective view of the antenna shown in FIG. 2;

FIG. 5 is a top perspective view of a carrier frame configured in accordance with certain embodiments, wherein the carrier frame is compatible with the antenna shown in FIG. 4;

FIG. 6 is a bottom perspective view of the carrier frame shown in FIG. 5;

FIG. 7 is a top-front perspective view of the fairing shown in FIG. 2;

FIG. 8 is a side view of the fairing shown in FIG. 7 (the opposing side view is symmetrically equivalent);

FIG. 9 is a bottom-rear perspective view of the fairing shown in FIG. 7;

FIG. 10 is a perspective view that shows an exemplary arrangement of components and features (for mounting, installation, and structural support) that reside underneath the fuselage skin of a host aircraft;

FIG. 11 is a plan view that includes some of the components and features shown in FIG. 10;

FIG. 12 is a perspective view that includes some of the components and features shown in FIG. 10;

FIG. 13 is a side perspective view of an embodiment of a support rib that is designed and configured to provide bird strike protection for the fairing shown in FIG. 7;

FIG. 14 is a perspective view that depicts the other side of the support rib shown in FIG. 13;

FIG. 15 is a top-rear perspective view of an embodiment of a support frame that is designed and configured to provide bird strike protection for the fairing shown in FIG. 7;

FIG. 16 is a top-front perspective view of the support frame shown in FIG. 15;

FIG. 17 is a top perspective view of an embodiment of a forward support fitting that is used to mount the carrier frame to the aircraft fuselage;

FIG. 18 is a side view of the forward support fitting;

FIG. 19 is an exploded perspective view that shows the forward support fitting, a portion of the carrier frame, and parts that form an attachment pin assembly for the forward support fitting;

FIG. 20 is a cross-sectional schematic view that shows the forward support fitting, the carrier frame, and a respective attachment pin assembly coupled together;

FIG. 21 is a top perspective view of an embodiment of an aft support fitting that is used to mount the carrier frame to the aircraft fuselage;

FIG. 22 is a side view of the aft support fitting;

FIG. 23 is an exploded perspective view that shows the aft support fitting, a portion of the carrier frame, and parts that form an attachment pin assembly for the aft support fitting;

FIG. 24 is a cross-sectional schematic view that shows the aft support fitting, the carrier frame, and a respective attachment pin assembly coupled together;

FIG. 25 is a bottom perspective view of an assembly that includes the antenna and the carrier frame coupled together;

FIG. 26 is a top-front perspective view of an assembly that includes the antenna, the carrier frame, and two forward support fittings;

FIG. 27 is a top-rear perspective view of an assembly that includes the antenna, the carrier frame, and two aft support fittings;

FIG. 28 is a top-front perspective view that depicts a portion of the aircraft fuselage with various components mounted thereto;

FIG. 29 is a top view that corresponds to FIG. 28;

FIG. 30 is a side view that corresponds to FIG. 28;

FIG. 31 is a front elevation view that corresponds to FIG. 28; and

FIG. 32 is a rear elevation view that corresponds to FIG. 28.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

The following description may refer to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

A fairing for a vehicle component, and its related installation and mounting system, are disclosed herein. In accordance with certain non-limiting embodiments, the vehicle component and fairing are deployed onboard an aircraft such as an airplane. However, it should be appreciated that embodiments of the disclosed subject matter can be utilized for other vehicle applications including, without limitation: trains; helicopters; automobiles; watercraft; submarines; monorails; amusement park rides; transportation systems; spacecraft; or the like. Moreover, although the exemplary application described herein relates to the mounting of an antenna component, the disclosed subject matter can be utilized in conjunction with other types of vehicle-mounted components, e.g., cameras, instruments, sensors, light fixtures, solar panels, aerodynamic features, structural elements, windows, or the like.

Certain embodiments of the disclosed subject matter relate to a system for mounting a component to an outer panel of a vehicle. The disclosed system includes an aerodynamic fairing and related assemblies for mounting an antenna component to the upper fuselage of an aircraft. In accordance with certain embodiments, the disclosed subject matter provides a solution for the installation of a flat panel satellite communication antenna and fairing on the fuselage skin of an aircraft. A flat panel antenna is secured and held within an adapter that resembles a picture frame, and the adapter is supported by four integral clevis features (utilizing, e.g., bolts, nuts, washers, bushings, spherical bearings, connecting pins), thus creating pinned connections to lug fittings mounted on the upper fuselage. These pinned connections create a system to mitigate load sharing of the normally encountered stresses on the fuselage. The adapter is surrounded by a low profile, aerodynamic fairing composed of composite material(s) and/or other suitable material. The fairing includes structural features and is suitably configured to be resistant to lightning strikes and bird impacts. In accordance with the disclosed implementation, the upper fuselage panel to which the fairing is mounted is reinforced by a system of doublers, frames, intercostals, and clips to react and distribute encountered stresses of the antenna and fairing safely to the aircraft structure.

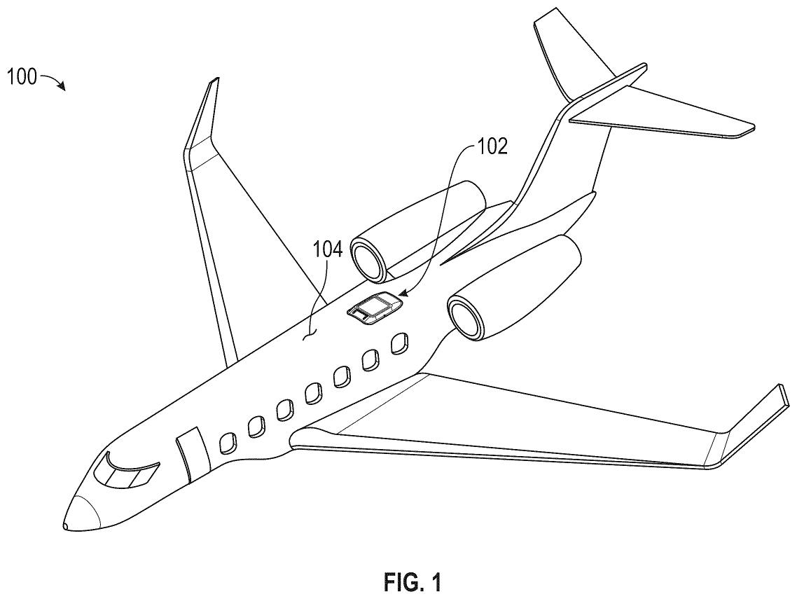

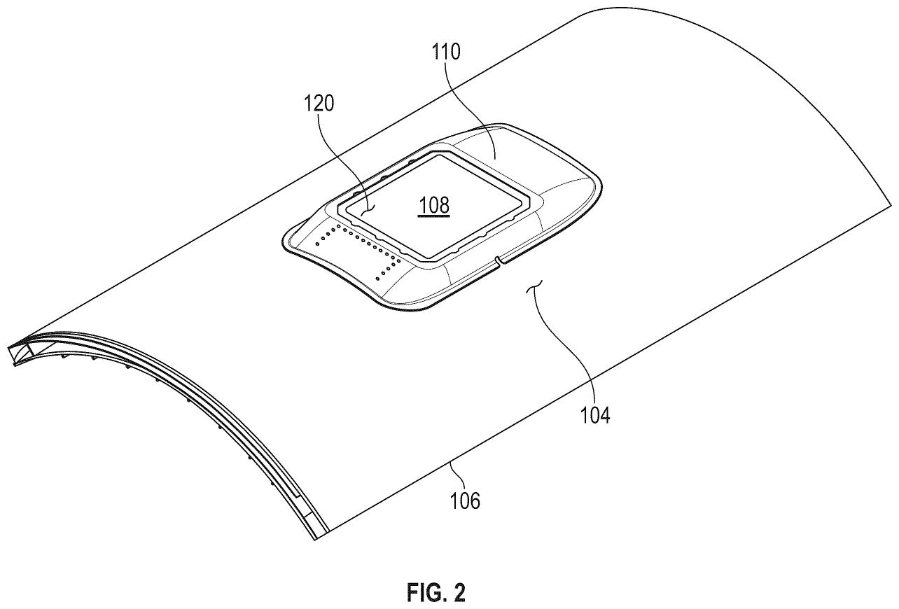

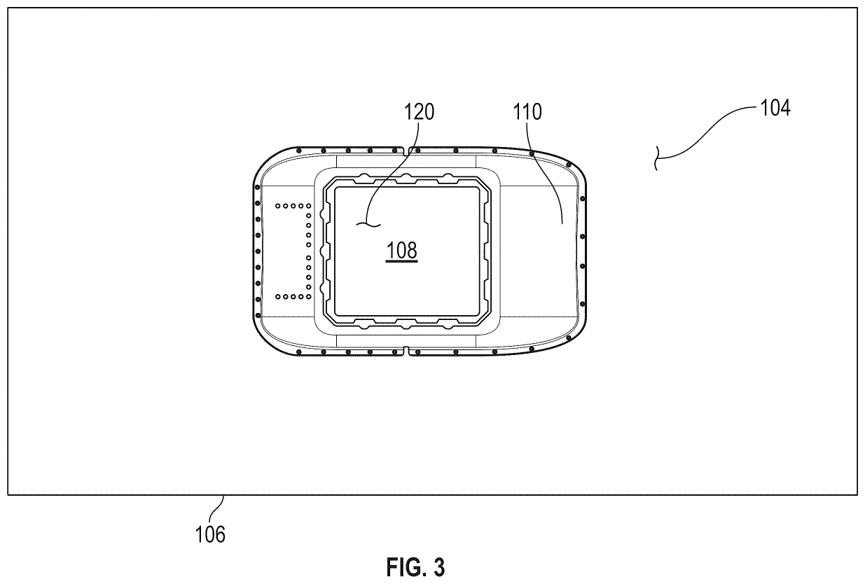

FIG. 1 is a top-front perspective view of an aircraft 100 with an exemplary embodiment of a component mounting system 102 attached to an outer panel (e.g., a fuselage skin 104 or a section thereof) of the aircraft 100. The system 102 includes an antenna and an associated fairing mounted to the fuselage skin 104. FIG. 2 is a top-front perspective view that depicts a section of the aircraft fuselage 106 with an antenna 108 and an associated aerodynamic fairing 110 mounted thereto, and FIG. 3 is a top view of the section of the fuselage 106 shown in FIG. 2. The exposed outer surface of the fuselage 106 corresponds to the fuselage skin 104.

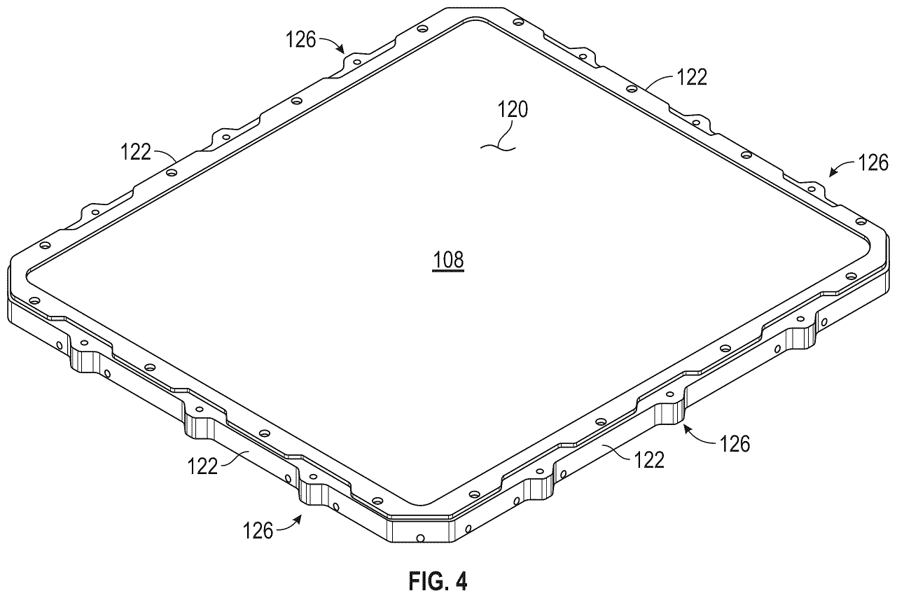

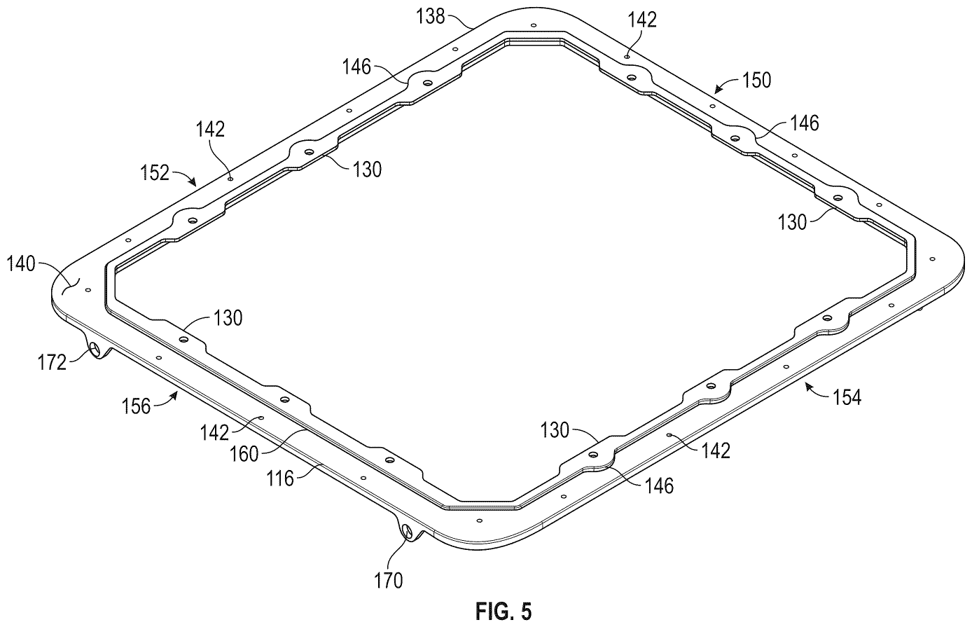

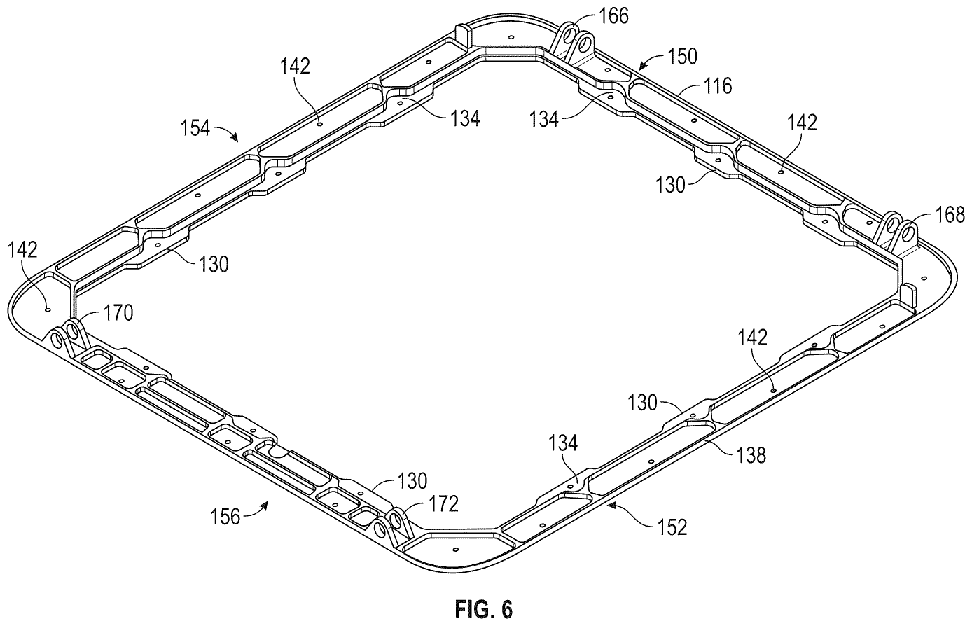

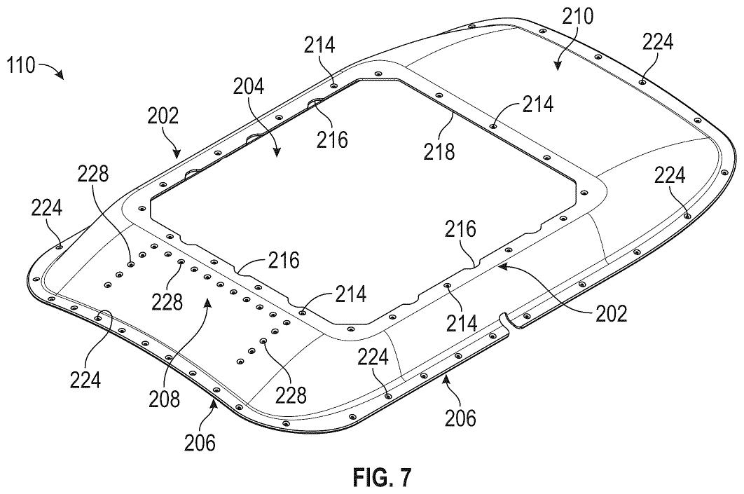

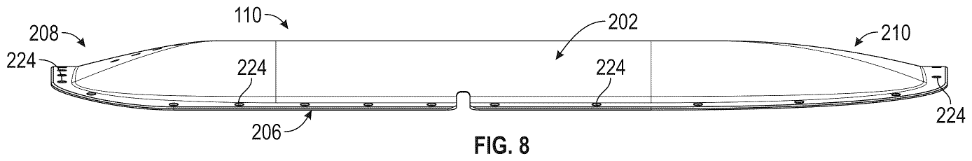

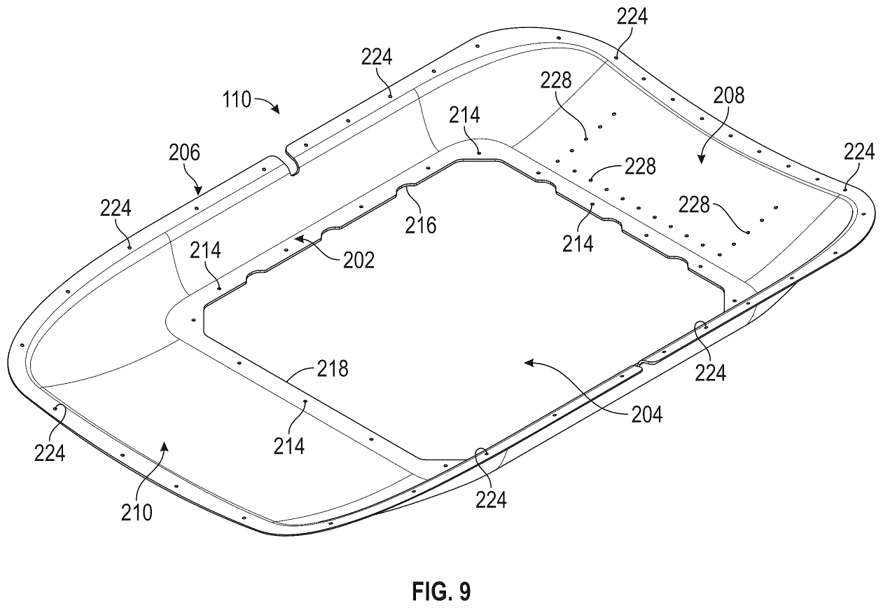

FIG. 4 is a top perspective view of an exemplary embodiment of the antenna 108, FIG. 5 is a top perspective view of a carrier frame 116 configured in accordance with certain embodiments, and FIG. 6 is a bottom perspective view of the carrier frame 116. FIG. 7 is a top-front perspective view of the fairing 110 by itself, FIG. 8 is a side view of the fairing 110, and FIG. 9 is a bottom-rear perspective view of the fairing 110.

As mentioned above, the described implementation of the antenna 108 is a flat panel satellite communication antenna having a low profile configuration. The perimeter region of the antenna 108 includes various mounting hole features, cutouts, and a particular shape that are taken into consideration. Referring to FIG. 4, the antenna 108 has a major surface 120 and a perimeter edge 122 that corresponds to a sidewall of the antenna 108. As explained in more detail below, the carrier frame 116 is shaped, sized, and configured to surround the perimeter edge 122 of the antenna 108. The carrier frame 116 is coupled to the antenna 108 and holds the antenna 108 such that the major surface 120 is exposed when the system 102 is installed on the host aircraft 100. The system 102 can be positioned in a desirable location on the fuselage skin 104 that enhances the electromagnetic performance of the antenna 108. In certain implementations, the fairing 110 and the carrier frame 116 are designed, configured, and manufactured for compatibility with the particular shape, size, dimensions, and layout of the antenna 108.

Referring to FIG. 4, the depicted embodiment of the antenna 108 includes a plurality of mounting locations 126 distributed around the outer perimeter of the antenna 108. For this particular implementation, the antenna 108 has twelve mounting locations 126 - three on each side. Each mounting location 126 includes or cooperates with a protrusion having a mounting hole formed therein. In addition, each mounting location 126 may be defined by a cutout or recess, such that a major upper surface of each mounting location 126 resides below an uppermost perimeter surface of the antenna 108. In this regard, FIG. 4 shows twelve depressions around the outer perimeter of the antenna 108, wherein the protrusions and mounting holes are co-located with the protrusions. These structural features of the antenna 108 cooperate with counterpart structural features of the carrier frame 116, as further described below.

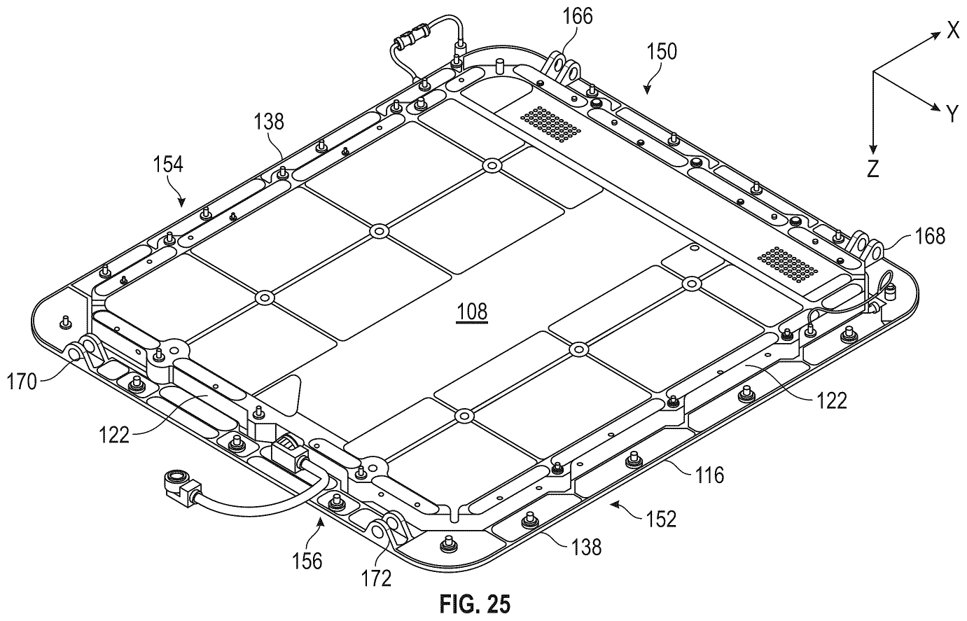

Referring to FIG. 5 and FIG. 6, the carrier frame 116 is suitably configured to be compatible with the particular shape, size, and dimensions of the antenna 108, and is configured to receive and hold the antenna 108 in accordance with the desired installation scheme. The carrier frame 116 is manufactured from a strong and tough material such as steel, aluminum, a composite material, plastic, or the like. The illustrated embodiment of the carrier frame 116 is designed to be placed overlying at least a portion of the antenna 108, and thereafter secured to the antenna 108 using bolts, screws, fasteners, clips, or the like. More specifically, the carrier frame 116 includes at least one connecting structure that overlaps an outer edge region of the antenna 108 to facilitate coupling to the antenna 108. When coupled to the antenna 108, the carrier frame 116 surrounds, encircles, or encloses the perimeter edge 122 of the antenna 108 (see, for example, FIGS. 25-29).

In accordance with the disclosed embodiment, the carrier frame 116 includes a plurality of mounting tabs 130 that are mapped to the mounting locations 126 of the antenna 108. Thus, the carrier frame 116 has twelve mounting tabs 130 that are arranged in a 1:1 relationship with the twelve mounting locations 126. Each mounting tab 130 has a fastener hole (which may be a threaded hole or a through hole) formed therein, which is located for indexing with a corresponding mounting hole of the antenna 108. When the carrier frame 116 is installed onto the antenna 108, the mounting tabs 130 reside in the recesses that are defined by the mounting locations 126. When the carrier frame 116 is attached to the antenna 108, the upper surfaces of the mounting tabs 130 are flush (or nearly flush) with the adjacent upper surface of the antenna 108. Flush mounting in this manner is desirable to improve aerodynamic performance and to provide a clean/smooth appearance.

Referring to FIG. 6, the carrier frame 116 includes a plurality of cutouts 134 that are mapped to the mounting locations 126 of the antenna 108. Each cutout 134 is co-located with a respective one of the mounting tabs 130. Accordingly, the carrier frame 116 has twelve cutouts 134 that are arranged in a 1:1 relationship with the twelve mounting tabs 130 and in a 1:1 relationship with the twelve mounting locations 126 of the antenna 108 (in FIG. 6, three of the cutouts 134 are hidden from view). The cutouts 134 are shaped, sized, and otherwise configured to mate with the protrusions of the mounting locations 126. In this regard, the mounting tabs 130, the cutouts 134, and the mounting locations 126 cooperate to ensure that the antenna 108 is installed in the proper orientation and arrangement relative to the carrier frame 116.

The top side of the carrier frame 116 (see FIG. 5) includes structures and features that facilitate installation of the aerodynamic fairing 110 onto the carrier frame 116. In this regard, the carrier frame 116 has an outer rim 138 that defines a mounting surface 140 for the fairing 110. The outer rim 138 has a plurality of mounting holes 142 formed therein and arranged in a layout that matches a fastener hole pattern of the fairing 110 (described in more detail below with reference to FIGS. 7-9). The non-limiting illustrated embodiment utilizes nineteen mounting holes 142. The top side of the carrier frame 116 also includes a plurality of protrusions 146 that are mapped to a corresponding number of cutouts 216 formed in the fairing 110 (described in more detail below with reference to FIGS. 7-9). As shown in FIG. 5, the exemplary embodiment includes nine protrusions 146, and each one is co-located with one of the mounting tabs 130. Three protrusions 146 are located at the front 150 of the carrier frame 116, three protrusions 146 are located at the left side 152 of the carrier frame 116, and three protrusions 146 are located at the right side 154 of the carrier frame. The back 156 of the carrier frame 116 does not include any of the protrusions 146 - a straight sidewall 160 is used at the back 156 instead of protrusions 146. The straight sidewall 160 provides an alignment reference to ensure correct orientation of the antenna 108 during installation. In accordance with the implementation shown here, the straight sidewall 160 accommodates an electrical connector that is located at the aft side of the antenna 108 (see FIG. 25).

The bottom side of the carrier frame 116 (see FIG. 6) includes or cooperates with structures and features that facilitate installation of the carrier frame 116 onto the aircraft fuselage 106, e.g., mounting bracket features. In accordance with certain embodiments, the carrier frame 116 includes a plurality of clevis attachment features 166, 168, 170, 172 integrally formed therein or attached thereto. The clevis attachment feature 166 is located at the front 150 of the carrier frame 116, near the right side 154; the clevis attachment feature 168 is located at the front 150 of the carrier frame 116, near the left side 152; the clevis attachment feature 170 is located at the back 156 of the carrier frame 116, near the right side 154; and the clevis attachment feature 172 is located at the back 156 of the carrier frame 116, near the left side 152. As explained in more detail below, the clevis attachment features 166, 168, 170, 172 correspond to a plurality of support fittings that are utilized to couple the carrier frame 116 to the fuselage 106.

The aerodynamic fairing 110 will now be described with reference to FIGS. 7-9. The fairing 110 can be implemented as a unitary one-piece component that is fabricated from any suitable material or composition of materials having the desired physical, mechanical, and aerodynamic characteristics. For example, an embodiment of the fairing 110 can be formed from a composite material, a metal such as aluminum, a plastic material, or the like. The fairing 110 is shaped, sized, and contoured to accommodate the antenna 108, which is configured for mounting to the aircraft fuselage 106 via the carrier frame 116. The fairing 110 is also shaped, sized, and contoured to be aerodynamic (low drag) and to reduce or minimize noise that is generated during flight. To this end, the fairing 110 is relatively flat and low profile, with a curved outline that is both aerodynamic and acoustically optimized. The fairing 110 generally includes, without limitation: an upper section 202; a main opening 204 defined in the upper section 202; a lower section 206; a leading section 208; and a trailing section 210.

The main opening 204 of the fairing 110 is shaped, sized, and positioned to accommodate at least a portion of the carrier frame 116, which can be coupled to the upper section 202 of the fairing 110. When affixed to the carrier frame 116, the region of the upper section 202 that defines the main opening 204 overlaps the mounting surface 140 of the carrier frame 116. Consequently, the mounting tabs 130 and the protrusions 146 of the carrier frame 116 reside within the main opening 204 and are exposed after installation. The main opening 204 also allows the major surface 120 of the antenna 108 to remain substantially or completely exposed after installation (see FIG. 2 and FIG. 3).

The region of the upper section 202 surrounding the main opening 204 has suitably configured and arranged mounting and/or interfacing features and structures to accommodate positioning and mounting of the carrier frame 116 in the correct orientation. For example, a series of fastener holes 214 positioned around the main opening 204 accommodate fasteners (e.g., screws, rivets, or bolts) that couple the fairing 110 to the carrier frame 116. In the depicted embodiment, the layout of the fastener holes 214 match the layout of the mounting holes 142 that reside in the carrier frame 116. The main opening 204 also includes or defines a plurality of cutouts 216 that are shaped, sized, and located to match the arrangement of protrusions 146 on the carrier frame 116. Accordingly, the upper section 202 of the fairing 110 has nine cutouts 216 corresponding to the nine protrusions 146: three cutouts 216 located at the front of the main opening 204; three cutouts 216 located at the left side of the main opening 204; and three cutouts located at the right side of the main opening 204. The main opening 204 also has a straight trailing edge 218 that corresponds to the straight sidewall 160 of the carrier frame 116.

The lower section 206 of the fairing 110 is configured and arranged for coupling to an outer panel (e.g., the fuselage skin 104) of the aircraft 100. For example, the lower section 206 of the fairing 110 includes a plurality of fastener holes 224 positioned near the outermost perimeter of the fairing 110. These fastener holes 224 accommodate fasteners (e.g., screws, rivets, or bolts) that couple the bottom of the fairing 110 against the aircraft fuselage 106. As explained in more detail below, these fasteners cooperate with mounting structure located below the fuselage skin 104.

The leading section 208 of the fairing 110 also includes a plurality of fastener holes 228 formed therein. These fastener holes 228 accommodate fasteners (e.g., screws, rivets, or bolts) that couple the fairing 110 against underlying components and/or reinforcing substructure that provide additional support and protection against objects striking the leading section 208 of the fairing 110 (such as bird strikes). In FIG. 7, the fastener holes 228 form a pattern that resembles an inverted “U” shape. The underlying substructure and related components are described in more detail below.

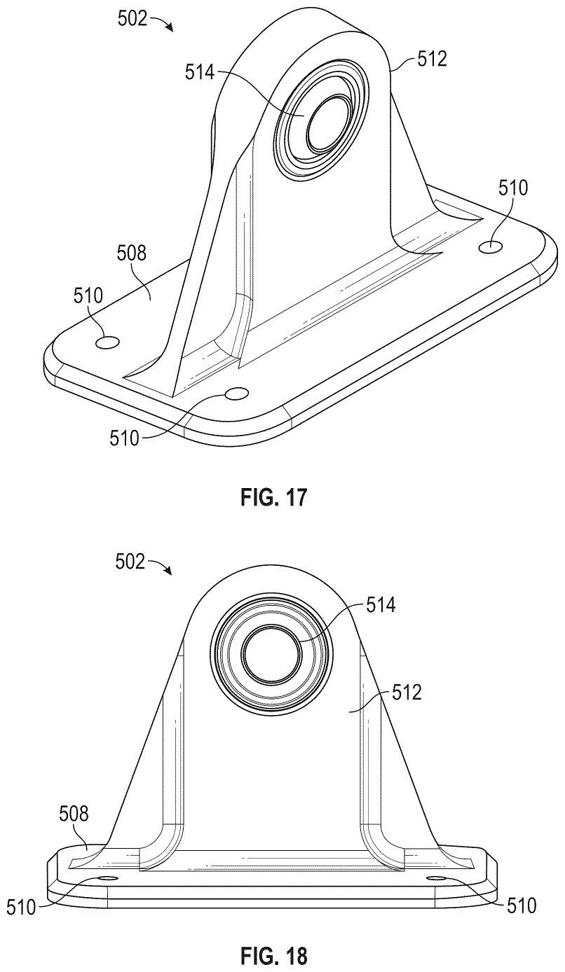

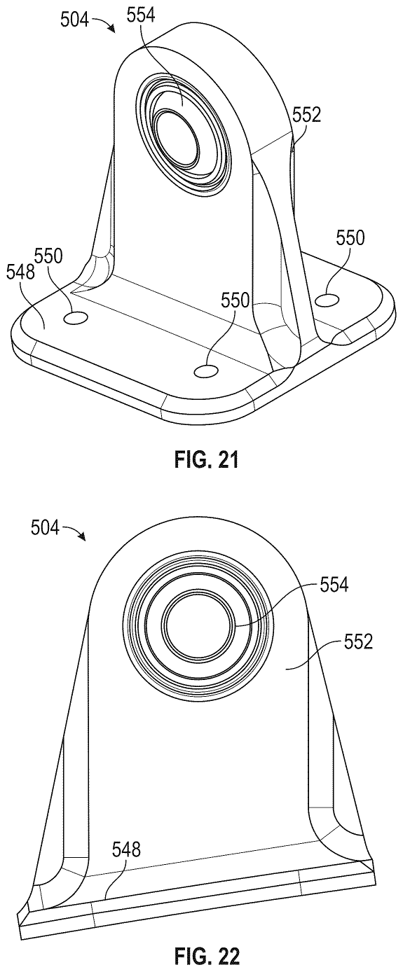

The component mounting system 102 includes a plurality of support fittings that are couplable between the carrier frame 116 and the outer panel of the aircraft 100 (e.g., a section of the aircraft fuselage 106). The support fittings are suitably configured to physically attach the carrier frame 116 to the outer panel of the aircraft 100. When the system 102 is fully installed onboard the aircraft 100, the support fittings secure the antenna 108 to the fuselage 106 because the antenna 108 is held by the carrier frame 116. Moreover, the support fittings indirectly couple the aerodynamic fairing 110 to the fuselage 106, by way of the carrier frame 116. The support fittings and their related functionality are described in more detail below with reference to FIGS. 17-27.

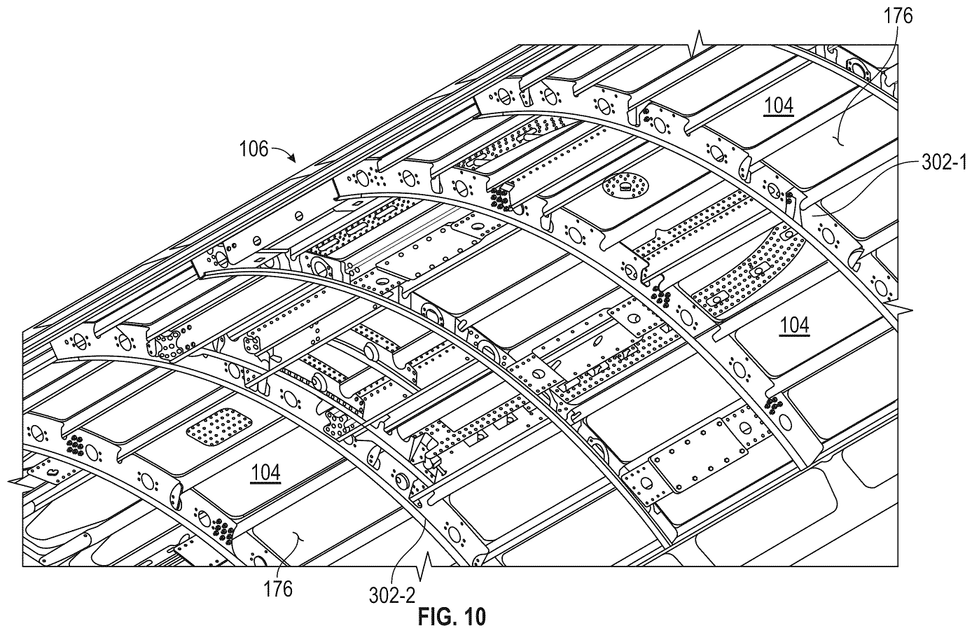

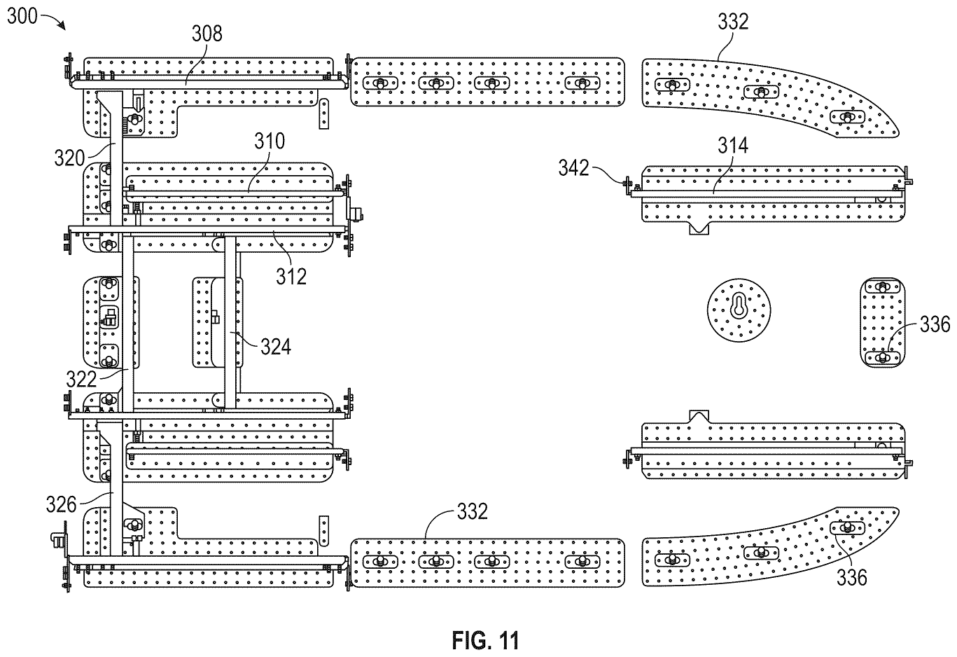

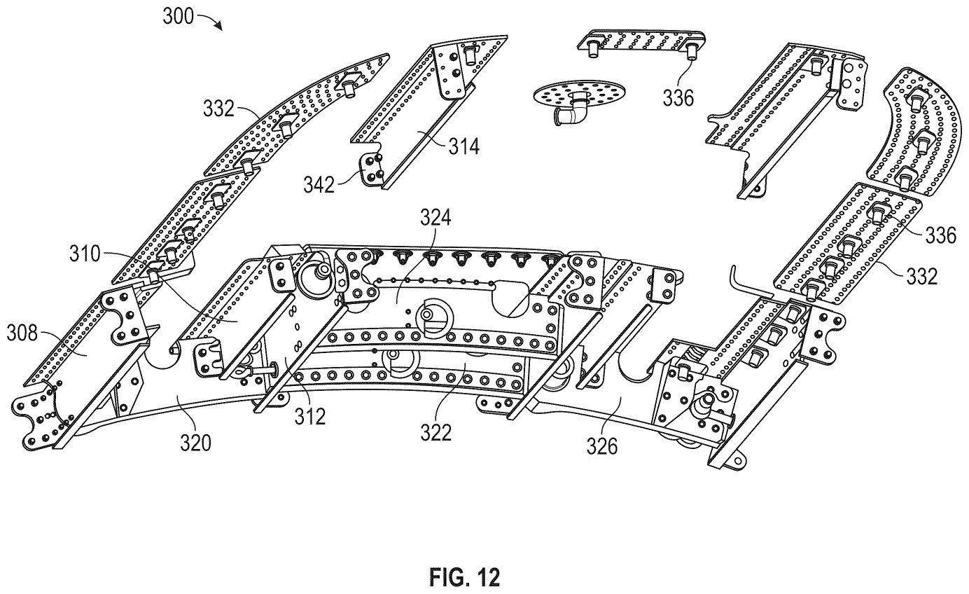

FIG. 10 is a perspective view that shows an exemplary installation arrangement of supporting and mounting elements, components, and features that reside underneath the fuselage skin 104 of the aircraft 100. FIG. 10 shows only a small section of the fuselage 106, along with various components, features, and structures utilized for installation of the antenna 108, the carrier frame 116, and the fairing 110 (which are hidden from view in FIG. 10 because they are located on the exterior side of the fuselage skin 104). The supporting and mounting elements are configured, positioned, and installed in an appropriate manner to accommodate attachment of the fairing 110 to the fuselage 106. The supporting and mounting elements are further configured, positioned, and arranged to structurally support the fairing 110 when it is installed on the aircraft 100. FIG. 11 and FIG. 12 are views that show some of the components and features of the installation arrangement 300 that are utilized for mounting, installation, and structural support.

FIG. 10 corresponds to a viewpoint from inside of the fuselage 106, looking upwards at the concave interior side 176 of the fuselage skin 104 (the opposing exterior side of the fuselage skin 104 is hidden from view in FIG. 10). FIG. 10 shows a number of upwardly curved frames 302 that form part of the fuselage 106. The frame 302-1 resides at or near the aft/rear end of the installation arrangement 300, and the frame 302-2 resides at or near the front end of the installation arrangement 300. The installation arrangement 300 is designed, configured, and implemented in an appropriate manner that contemplates existing structure and components of the fuselage 106, e.g., frames, stringers, skin, intercostals, brackets, and conduits. In this regard, the installation arrangement 300 represents a supplemental or reinforcing assembly of components that can be joined with existing elements of the fuselage 106 to provide additional structural integrity and robustness. As depicted in FIG. 10, the installation arrangement 300 can be coupled to the interior side 176 of the fuselage skin 104. The various elements of the installation arrangement 300 are positioned for accurate correspondence with respective overlying features of the system 102 (e.g., mounting fixtures, support structures, mounting holes of the aerodynamic fairing 110, electrical connectors or cables associated with the antenna 108).

FIG. 11 and FIG. 12 depict certain components of the installation arrangement 300 in the absence of the fuselage 106, the fuselage skin 104, and components overlying the fuselage skin 104. At least some of the depicted components are also shown in FIG. 10 (for simplicity and ease of illustration, the individual components are not labeled with reference numbers in FIG. 10). An embodiment of the installation arrangement 300 may include the following components to secure the carrier frame 116 and the fairing 110 to the aircraft fuselage 106: intercostal supports 308, 310, 312, 314; cross frames 320, 322, 324, 326; doublers 332; fastener plates 336; and brackets 342. In FIG. 11 and FIG. 12, only four of eight intercostal supports are numbered, only two doublers 332 are identified, only two fastener plates 336 are identified, and only one bracket 342 is identified. Any number of doublers 332 can be utilized to provide structural support at designated areas underlying the fuselage skin 104 (which isn't shown in FIG. 11 or FIG. 12). Any number of fastener plates 336 can be utilized to accommodate mounting hardware for components that reside outside the fuselage 106. Any number of brackets 342 (which may be realized in different shapes, sizes, and configurations) can be utilized to couple adjacent structural components together. For example, brackets 342 can be used to couple an intercostal support to a cross frame.

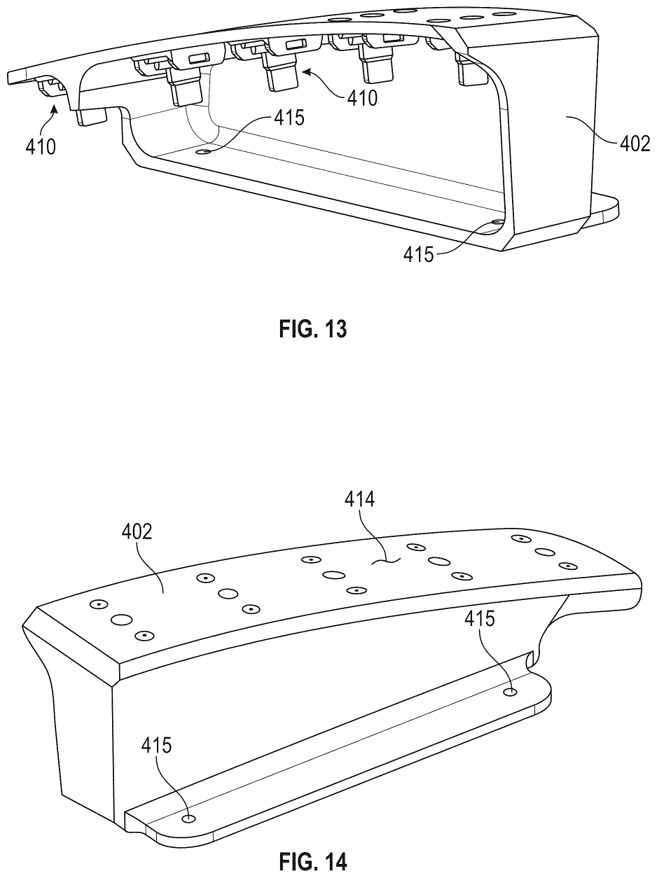

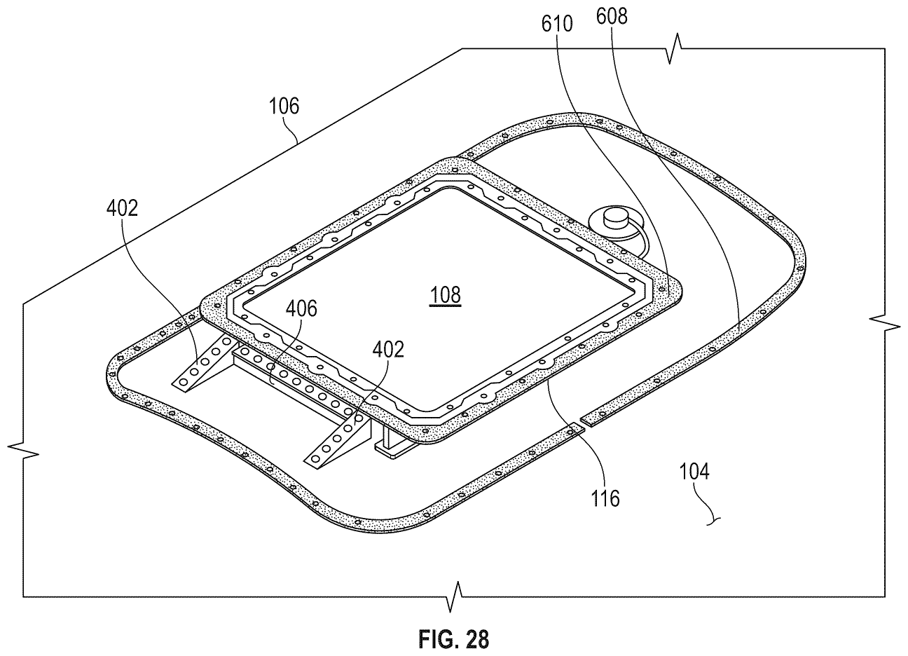

As mentioned above with reference to FIG. 7, the component mounting system 102 may include a suitably configured reinforcing substructure that is coupled between the outer panel (fuselage skin 104) of the aircraft 100 and the leading section 208 of the fairing 110. The reinforcing substructure is configured, arranged, and installed to provide structural support underneath the leading section 208 for protection against object strikes, e.g., bird strikes during flight. Referring to FIGS. 13-16, the illustrated embodiment of the reinforcing substructure is implemented with at least one support rib 402 and at least one support frame 406. The illustrated embodiment of the system 102 includes two longitudinal support ribs 402 and one transverse support frame 406 (see FIGS. 28-31). FIG. 13 and FIG. 14 depict a support rib 402 that can be used for one side of the reinforcing substructure (e.g., the left side). A mirror image version of the support rib 402 can be used for the other side of the reinforcing substructure.

FIG. 13 shows the support rib 402 with five fastener plates 410 attached thereto, and FIG. 14 depicts the other side of the support rib 402 with the attached fastener plates 410. The fastener plates 410 receive threaded fasteners to attach the overlying fairing 110 to the upper surface 414 of the support rib 402. The base of the support rib 402 includes fastener holes 415 formed therein. These fastener holes 415, which may be threaded holes or through holes, accommodate fasteners (e.g., screws, bolts, rivets) that are used to attach the support rib 402 to the aircraft fuselage 106.

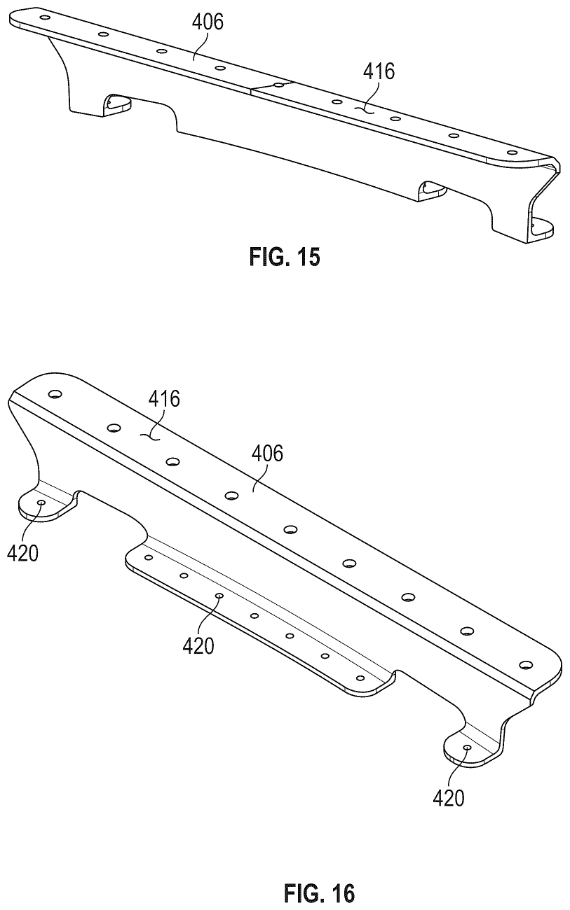

FIG. 15 is a top-rear perspective view of the support frame 406, and FIG. 16 is a top-front perspective view of the support frame 406. Although not shown in FIG. 15 or FIG. 16, the support frame 406 accommodates nine fastener plates (similar to the fastener plates 410) that receive threaded fasteners to attach the overlying fairing 110 to the upper surface 416 of the support frame 406. The base of the support frame 406 includes fastener holes 420 formed therein. These fastener holes 420, which may be threaded holes or through holes, accommodate fasteners (e.g., screws, bolts, rivets) that are used to attach the support frame 406 to the aircraft fuselage 106.

As explained above with reference to FIG. 5 and FIG. 6, the carrier frame 116 can be attached to the fuselage 106 using a number of support fittings. The exemplary deployment described here utilizes four support fittings, which are coupled at or near the corners of the carrier frame 116. In this regard, FIGS. 17-20 depict a forward support fitting 502 that is configured to couple the carrier frame 116 to the aircraft fuselage 106, and FIGS. 21-24 depict an aft support fitting 504 that is configured to couple the carrier frame 116 to the aircraft fuselage 106. In practice, two instantiations of the forward support fitting 502 (which may be mirror image versions of each other) and two instantiations of the aft support fitting 504 (which may be mirror image versions of each other) are utilized to mount the carrier frame 116 to the fuselage 106.

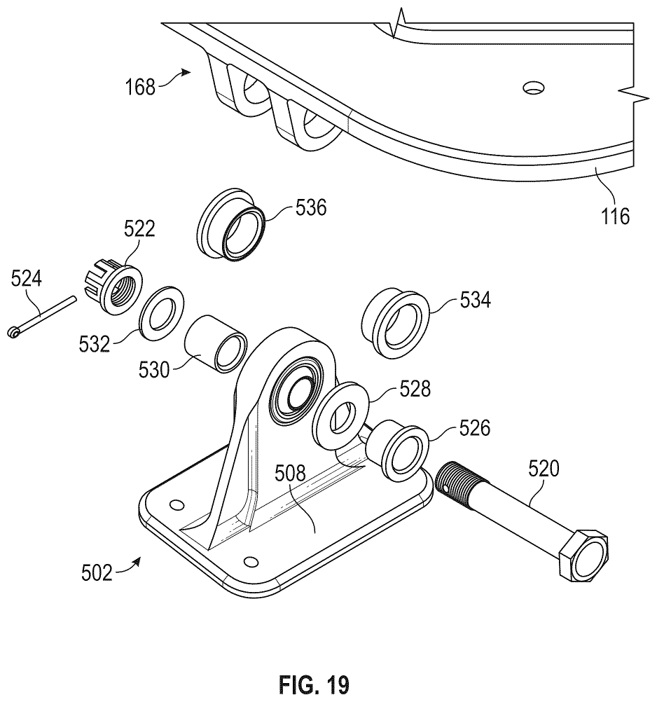

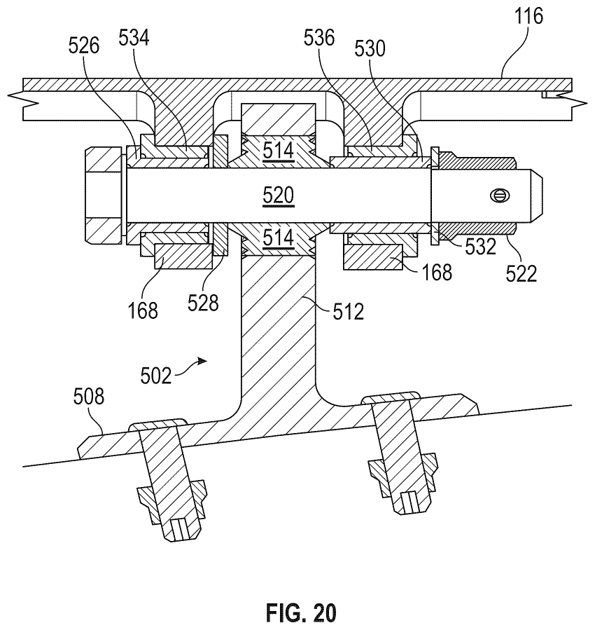

The forward support fitting 502 includes, without limitation: a base 508; fastener holes 510 formed in the base 508; a support column 512 extending from the base 508; and a bearing component 514 (such as a spherical bearing), which may be held in a hole formed in the support column 512. The base 508 and its fastener holes 510 are configured and arranged to accommodate mounting of the forward support fitting 502 to the fuselage 106. In this regard, the arrangement of the fastener holes 510 matches an arrangement of fastener plates that form a part of the underlying installation arrangement 300. Threaded fasteners can be installed in the fastener holes 510 and tightened to secure the forward support fitting 502 against the fuselage 106. The support column 512 extends above the base 508 with a specified height to hold the carrier frame 116 above the fuselage 106 by the desired amount. The bearing component 514 is shaped, sized, and dimensioned to accommodate hardware components associated with a respective attachment pin assembly (see FIG. 19 and FIG. 20). As described in more detail below, the upper section of the support column 512 is shaped and sized for compatibility with the front clevis attachment features 166, 168 of the carrier frame 116.

FIG. 19 depicts the forward support fitting 502, a section of the carrier frame 116, and a number of parts that form an attachment pin assembly that is utilized to couple the forward support fitting 502 to the carrier frame 116. More specifically, the attachment pin assembly couples the forward support fitting 502 to its corresponding clevis attachment feature 168. In accordance with the embodiment depicted in FIG. 19, the attachment pin assembly includes, without limitation: a bolt, threaded fastener, or pin 520; a castellated nut 522 that is compatible with the pin 520; a cotter pin 524 that is compatible with the castellated nut 522 and the pin 520; a first flanged sleeve 526; a first washer 528; a sleeve 530; a second washer 532; a second flanged sleeve 534; and a third flanged sleeve 536. FIG. 20 shows the arrangement of these parts as installed and coupled to the forward support fitting 502 and the clevis attachment feature 168.

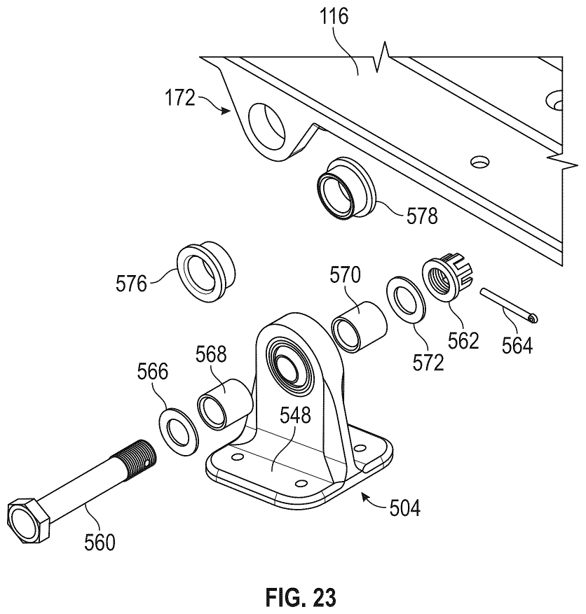

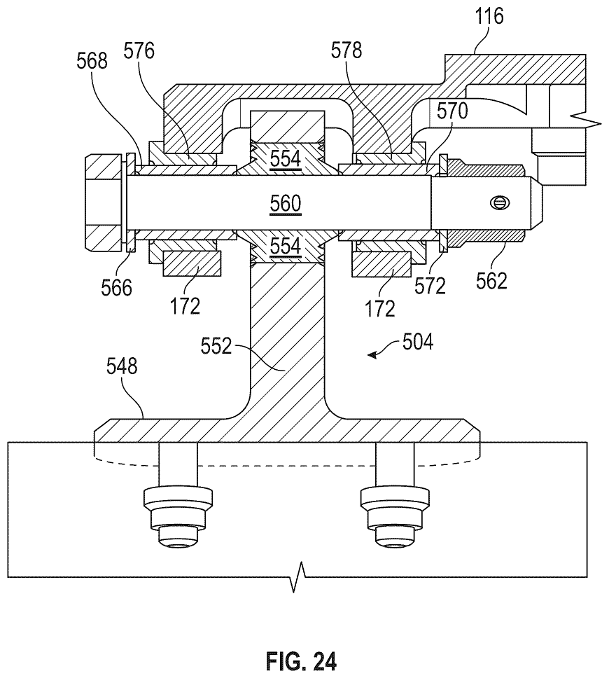

Referring to FIG. 20, the flanged sleeves 534, 536 are installed into the through holes of the clevis attachment feature 168. The second flanged sleeve 534 receives the first flanged sleeve 526, and the third flanged sleeve 536 receives the sleeve 530. The pin 520 and the washers 528, 532 can then be installed such that the pin 520 resides in the through holes defined in the first flanged sleeve 526, the first washer 528, the bearing component 514, the sleeve 530, and the second washer 532. The nut 522 is then threaded onto the end of the pin 520, tightened, and secured with the cotter pin 524. The attachment pin assembly depicted in FIG. 19 and FIG. 20 is suitably configured and installed to inhibit translation of the carrier frame 116 relative to the forward support fitting 502 in the dimension that corresponds to the major longitudinal axis of the pin 520 (i.e., the horizontal dimension of FIG. 20). This configuration can be utilized to clamp a support fitting to its respective clevis attachment feature in a fixed and stationary position. In contrast, the attachment pin assembly depicted in FIG. 23 and FIG. 24 facilitates an amount of translation of the carrier frame 116 relative to the support fitting. These aspects of the attachment pin assemblies are described in more detail below.

The aft support fitting 504 includes, without limitation: a base 548; fastener holes 550 formed in the base 548; a support column 552 extending from the base 548; and a bearing component 554 (such as a spherical bearing), which may be held in a hole formed in the the support column 552. The base 548 and its fastener holes 550 are configured and arranged to accommodate mounting of the aft support fitting 504 to the fuselage 106. In this regard, the arrangement of the fastener holes 550 matches an arrangement of fastener plates that form a part of the underlying installation arrangement 300. Threaded fasteners can be installed in the fastener holes 550 and tightened to secure the aft support fitting 504 against the fuselage 106. The support column 552 extends above the base 548 with a specified height to hold the carrier frame 116 above the fuselage 106 by the desired amount. The bearing component 554 is shaped, sized, and dimensioned to accommodate hardware components associated with a respective attachment pin assembly (see FIG. 23 and FIG. 24). As described in more detail below, the upper section of the support column 552 is shaped and sized for compatibility with the aft clevis attachment features 170, 172 of the carrier frame 116.

FIG. 23 depicts the aft support fitting 504, a section of the carrier frame 116, and a number of parts that form an attachment pin assembly that is utilized to couple the aft support fitting 504 to the carrier frame 116. More specifically, the attachment pin assembly couples the aft support fitting 504 to its corresponding clevis attachment feature 170, 172. In accordance with the embodiment depicted in FIG. 23, the attachment pin assembly includes, without limitation: a bolt, threaded fastener, or pin 560; a castellated nut 562 that is compatible with the pin 560; a cotter pin 564 that is compatible with the castellated nut 562 and the pin 560; a first washer 566; a first sleeve 568; a second sleeve 570; a second washer 572; a first flanged sleeve 576; and a second flanged sleeve 578. FIG. 24 shows the arrangement of these parts as installed and coupled to the aft support fitting 504 and the clevis attachment feature 172.

Referring to FIG. 24, the flanged sleeves 576, 578 are installed into the through holes of the clevis attachment feature 172. The first flanged sleeve 576 receives the first sleeve 568, and the second flanged sleeve 578 receives the second sleeve 570. The pin 560 and the washers 566, 572 can then be installed such that the pin 560 resides in the through holes defined in the first washer 566, the first sleeve 568, the bearing component 554, the second sleeve 570, and the second washer 572. The nut 562 is then threaded onto the end of the pin 560, tightened, and secured with the cotter pin 564. The attachment pin assembly depicted in FIG. 23 and FIG. 24 is suitably configured and installed to accommodate translation of the carrier frame 116 relative to the aft support fitting 504 in the dimension that corresponds to the major longitudinal axis of the pin 560 (i.e., the horizontal dimension of FIG. 24). More specifically, the clevis attachment feature 172 is free to laterally slide (by an amount that is limited by the physical dimensions) relative to the fixed position of the attachment pin assembly and the aft support fitting 504. This configuration can be utilized to couple a support fitting to its respective clevis attachment feature in a manner that allows an amount of translation of the carrier frame 116 relative to the support fitting.

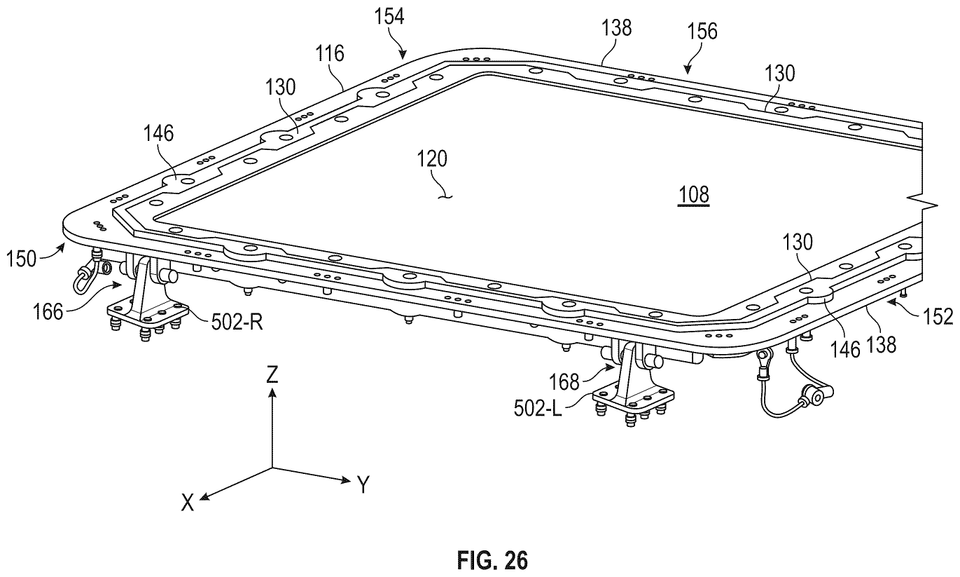

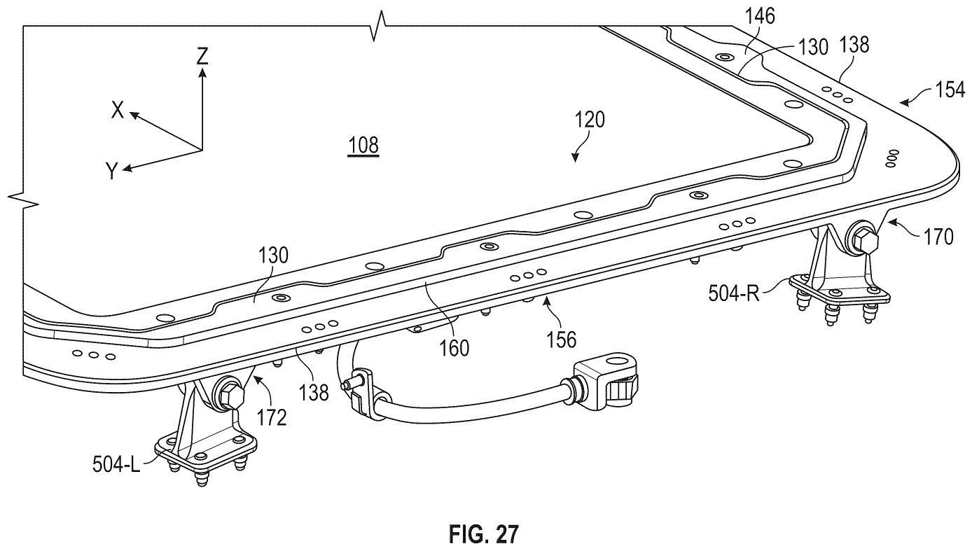

FIG. 25 is a bottom view that shows the antenna 108 coupled to the carrier frame 116. FIG. 26 is a top-front view that shows the antenna 108 coupled to the carrier frame 116, along with two forward support fittings 502. FIG. 27 is a top-rear view that shows the antenna 108 coupled to the carrier frame 116, along with two aft support fittings 504. Each of the support fittings 502, 504 is coupled to a corresponding one of the clevis attachment features 166, 168, 170, 172 (using a respective attachment pin assembly). In this regard, the support fittings 502 and their respective attachment pin assemblies are utilized to couple the front section of the carrier frame 116 to the fuselage skin 104 (or any outer panel) of the aircraft 100, and the support fittings 504 and their respective attachment pin assemblies are utilized to couple the rear section of the carrier frame 116 to the fuselage skin 104 (or any outer panel) of the aircraft 100.

FIGS. 25-27 depict a three-axis reference coordinate system that includes an x-axis corresponding to the major longitudinal dimension of the aircraft 100, a y-axis corresponding to the lateral dimension of the aircraft, and a z-axis corresponding to a vertical dimension of the aircraft 100. Referring to FIG. 26, the clevis attachment feature 166, the forward support fitting 502-R, and the respective attachment pin assembly are suitably configured, arranged, and installed to permit an amount of rotation about the longitudinal axis of the associated pin 520 (which is an axis parallel to the y-axis). Likewise, the clevis attachment feature 168, the forward support fitting 502-L, and the respective attachment pin assembly are suitably configured, arranged, and installed to permit an amount of rotation about the longitudinal axis of the associated pin 520 (which is an axis parallel to the y-axis). Referring to FIG. 27, the clevis attachment feature 170, the aft support fitting 504-R, and the respective attachment pin assembly are suitably configured, arranged, and installed to permit an amount of rotation about the longitudinal axis of the associated pin 520 (which is an axis parallel to the x-axis). Likewise, the clevis attachment feature 172, the aft support fitting 504-L, and the respective attachment pin assembly are suitably configured, arranged, and installed to permit an amount of rotation about the longitudinal axis of the associated pin 520 (which is an axis parallel to the x-axis).

The clevis attachment features, the support fittings, the attachment pin assemblies, and the associated hardware components are suitably configured and assembled to contemplate expansion, contraction, or movement of materials (e.g., caused by flight operations, temperature changes, environmental changes). In accordance with the exemplary embodiment described here, both of the aft mounting arrangements inhibit or prevent y-axis and z-axis translation, but allow an amount of x-axis translation (where the x-axis corresponds to the major longitudinal axis of the aircraft, the y-axis corresponds to the left-right horizontal axis of the aircraft, and the z-axis corresponds to the vertical dimension). In contrast, one of the two forward mounting arrangements inhibits or prevents x-axis, y-axis, and z-axis translation, while the other forward mounting arrangement inhibits or prevents x-axis and z-axis translation, but allows y-axis translation.

More specifically, the right-side forward support fitting 502-R, its clevis attachment feature 166, and its corresponding attachment pin assembly are cooperatively configured to inhibit translation along the x-axis, to inhibit translation along the z-axis, and to allow some translation along the y-axis. In contrast, the left-side forward support fitting 502-L, its clevis attachment feature 168, and its corresponding attachment pin assembly are cooperatively configured to inhibit translation in all three axes. In other words, the front left section of the carrier frame 116 is effectively pinned (fixed) to the forward support fitting 502-L. Referring to FIG. 27, the right-side aft support fitting 504-R, its clevis attachment feature 170, and its corresponding attachment pin assembly are cooperatively configured to inhibit translation along the y-axis, to inhibit translation along the z-axis, and to allow some translation along the x-axis. Similarly, the left-side aft support fitting 504-L, its clevis attachment feature 172, and its corresponding attachment pin assembly are cooperatively configured to inhibit translation along the y-axis, to inhibit translation along the z-axis, and to allow some translation along the x-axis.

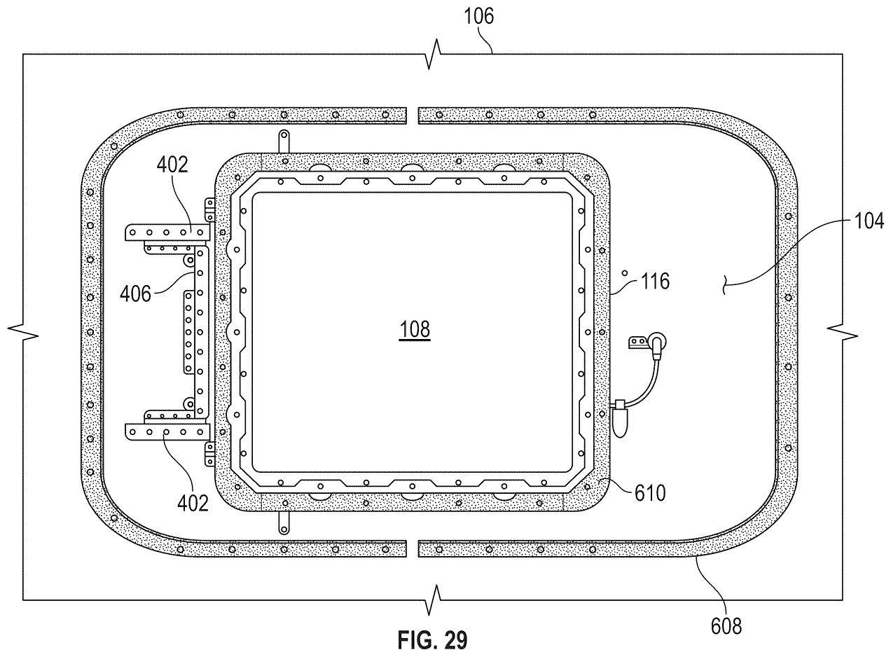

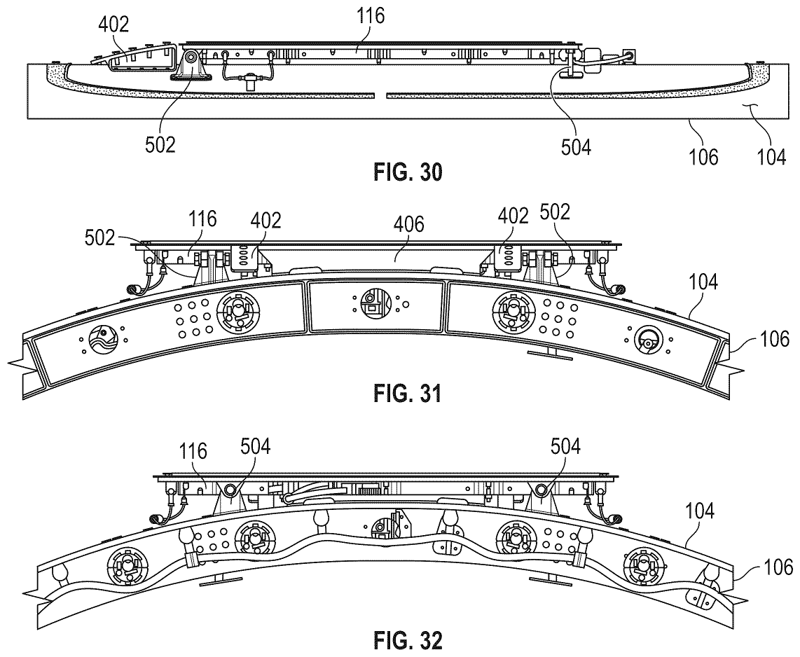

FIG. 28 is a top-front perspective view that depicts a portion of the aircraft fuselage 106 with various components mounted thereto (the aerodynamic fairing 110 is not shown). FIG. 29 is a top view that corresponds to FIG. 28, FIG. 30 is a side view that corresponds to FIG. 28, FIG. 31 is a front elevation view that corresponds to FIG. 28, FIG. 32 is a rear elevation view that corresponds to FIG. 28. Most of the components depicted in FIGS. 28-32 are hidden from view and covered by the fairing 110 (see FIGS. 1-3). These figures depict an exemplary installation of the antenna 108, the carrier frame 116, the support ribs 402, the support frame 406; and the support fittings 502, 504 overlying the fuselage skin 104. FIG. 28 and FIG. 29 also show a fairing seal 608 (e.g., at least one gasket, a layer of sealant material, or the like) that is positioned and configured to seal the fairing 110 against the fuselage skin 104. A carrier seal 610 (e.g., at least one gasket, a layer of sealant material, or the like) is positioned and configured to seal the fairing 110 against the carrier frame 116 (and/or against the antenna 108). Seals and/or sealing material may also be used to seal the upper surfaces of the support ribs 402 and the support frame 406 against the fairing 110. The carrier frame 116 serves as an adapter and interface that accommodates mounting of the antenna 108 to an edge region of the fairing 110 that is adjacent to the main opening 204 of the fairing 110. Referring again to FIG. 11, the underlying internal components are used to secure the overlying external components (shown in FIGS. 28-32) to the fuselage 106.

In accordance with certain exemplary implementations, the following procedure can be performed to install the antenna 108 and associated antenna fairing 110 onto a vehicle, such as the aircraft 100. As an initial step, the carrier frame 116 and the four support fittings 502, 504 are assembled to form a carrier subassembly. The support fittings 502, 504 have mounting holes formed therein, and the bases 508, 548 of the support fittings 502, 504 serve as mounting feet for the carrier subassembly. A template that includes the desired hole pattern (e.g., a printed mylar sheet) is introduced on the exterior surface of the fuselage skin 104 and is located and secured to identify the desired mounting locations for the support fittings 502, 504. The template serves as a guide to drill a number of holes for purposes of temporarily installing the support fittings 502, 504 in the designated locations, which in turn facilitates proper positioning, alignment, and installation of other structures and components (e.g., components that are installed inside of the fuselage 106). Temporary fasteners are used at this point for reasons that will become apparent.

For this example, the mounting holes of each support fitting 502, 504 correspond to reference locations on the corresponding intercostal support structure (e.g., the installation arrangement 300 described above), which is installed underneath the fuselage skin 104. Thus, the guide holes can serve as references to locate the installation positions of intercostal support structures, doubler components, support frames, and the like. The mylar template includes identifying indica corresponding to all of the required installation holes that will penetrate the fuselage skin 104 (for fasteners, bolts, rivets, etc.). This allows technicians to pin up the different parts on the inside and outside of the fuselage skin 104. To this end, there can be various coordinate holes associated with components to be installed, such as the support fittings 502, 504, the support ribs 402, the support frame 406, etc.

The coordinated holes are used to temporarily locate structures atop the fuselage skin 104, which in turn facilitates correct positioning and installation of the internal components. After all of the coordinated holes have been formed, a technician inside of the fuselage 106 can proceed to pin up the doublers, the intercostal supports, support frames, and the like. The reference holes and reference locations can then be used as a guide to drill or otherwise fabricate the remaining holes that are needed to install the various components. After drilling or otherwise creating the necessary holes in the fuselage, the temporarily installed components are removed to facilitate cleaning, deburring, etc.

The doublers 332 (some of which may have fastener plates installed thereon) are coupled to the interior surface of the fuselage skin 104, for example, by riveting. The interior support structures can then be installed: the intercostal supports, the cross frames, interconnecting brackets, and the like. Outside of the fuselage 106, the support ribs 402 and the support frame 406 (for object strike protection) and the carrier subassembly are affixed to the fuselage skin 104 at the predetermined locations. Gaskets, sealants, and/or other treatments are applied to seal the fuselage as needed, resulting in the state depicted in FIGS. 28-32. Next, the aerodynamic fairing 110 is introduced and secured to the carrier frame 116, the fuselage skin 104, the support ribs 402, and the support frame 406, resulting in the completed state depicted in FIGS. 1-3.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system for mounting a component to an outer panel of a vehicle, the system comprising:
a carrier frame configured to receive and hold the component;
a plurality of support fittings, each being couplable between the carrier frame and the outer panel of the vehicle, wherein the support fittings are configured to physically attach the carrier frame to the outer panel of the vehicle; and
a fairing having an upper section with an opening defined therein, and having a lower section configured and arranged for coupling to the outer panel of the vehicle, wherein the opening is shaped and sized to accommodate at least a portion of the carrier frame, and wherein the carrier frame is coupled to the upper section of the fairing.

2. The system of claim 1, wherein:
the carrier frame is configured to surround a perimeter edge of the component; and
the carrier frame holds the component such that a major surface of the component is exposed.

3. The system of claim 1, wherein:
the carrier frame includes a plurality of clevis attachment features corresponding to the plurality of support fittings; and
each support fitting of the plurality of support fittings is coupled to a corresponding one of the clevis attachment features, using an attachment pin assembly.

4. The system of claim 3, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the x-axis, to inhibit translation along the z-axis, and to allow translation along the y-axis.

5. The system of claim 4, wherein the designated clevis attachment feature, the corresponding support fitting, and the corresponding attachment pin assembly are utilized to couple a front section of the carrier frame to the outer panel of the vehicle.

6. The system of claim 3, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the y-axis, to inhibit translation along the z-axis, and to allow translation along the x-axis.

7. The system of claim 6, wherein the designated clevis attachment feature, the corresponding support fitting, and the corresponding attachment pin assembly are utilized to couple a rear section of the carrier frame to the outer panel of the vehicle.

8. The system of claim 3, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the x-axis, to inhibit translation along the z-axis, and to inhibit translation along the y-axis.

9. The system of claim 1, further comprising a reinforcing substructure coupled between the outer panel of the vehicle and a leading section of the fairing, wherein the reinforcing substructure is configured and arranged to provide structural support underneath the leading section of the fairing for protection against objects striking the leading section of the fairing.

10. The system of claim 1, wherein:
the outer panel has an exterior side and an opposing interior side;
the system further comprises an arrangement of supporting and mounting elements coupled to the interior side of the outer panel; and
the arrangement of supporting and mounting elements is configured to accommodate attachment of the fairing to the outer panel and is further configured to structurally support the fairing when the fairing is attached to the outer panel.

11. A system configured to be mounted to an outer panel of a vehicle, the system comprising:
an antenna component;
a carrier frame coupled to the antenna component, the carrier frame comprising a plurality of clevis attachment features;
a plurality of support fittings, each being couplable between one of the clevis attachment features and the outer panel of the vehicle; and
an aerodynamic fairing having an upper section with an opening defined therein, and having a lower section configured and arranged for coupling to the outer panel of the vehicle, wherein the opening is shaped and sized to accommodate at least a portion of the carrier frame, and wherein the carrier frame is coupled to the upper section of the fairing.

12. The system of claim 11, wherein the antenna component is a flat panel satellite communication antenna.

13. The system of claim 11, wherein:
each support fitting of the plurality of support fittings is coupled to a corresponding one of the clevis attachment features, using an attachment pin assembly.

14. The system of claim 13, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the x-axis, to inhibit translation along the z-axis, and to allow translation along the y-axis.

15. The system of claim 13, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the y-axis, to inhibit translation along the z-axis, and to allow translation along the x-axis.

16. The system of claim 13, wherein:
a three-axis reference coordinate system includes an x-axis corresponding to a longitudinal dimension of the vehicle, a y-axis corresponding to a lateral dimension of the vehicle, and a z-axis corresponding to a vertical dimension of the vehicle; and
a designated clevis attachment feature of the plurality of clevis attachment features, a corresponding support fitting, and a corresponding attachment pin assembly are cooperatively configured to inhibit translation along the x-axis, to inhibit translation along the z-axis, and to inhibit translation along the y-axis.

17. The system of claim 11, further comprising a reinforcing substructure coupled between the outer panel of the vehicle and a leading section of the fairing, wherein the reinforcing substructure is configured and arranged to provide structural support underneath the leading section of the fairing for protection against objects striking the leading section of the fairing.

18. The system of claim 11, wherein:
the outer panel has an exterior side and an opposing interior side;
the system further comprises an arrangement of supporting and mounting elements coupled to the interior side of the outer panel; and
the arrangement of supporting and mounting elements is configured to accommodate attachment of the fairing to the outer panel and is further configured to structurally support the fairing when the fairing is attached to the outer panel.

19. A vehicle comprising the system of claim 11.

20. The vehicle of claim 19, wherein:
the vehicle is an aircraft;
the outer panel corresponds to a fuselage skin of the aircraft; and
the antenna component is a flat panel satellite communication antenna.
